(19) United States
(12) Patent Application Publication
(10) Pub. No.: US 2009/0058320 A1
(43) Pub. Date: Mar. 5, 2009

(54) SYSTEM AND METHOD FOR CONTROLLING LIGHTING PATTERNS OF AN LED

(75) Inventors: LUNG-YI CHOU, Tu-Cheng (TW); KUO-WEI CHANG, Tu-Cheng (TW); CHIH-HSIEN YANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/938,306

(22) Filed: Nov. 12, 2007

(30) Foreign Application Priority Data
Aug. 31, 2007 (CN) 200710201567.5

(51) Int. Cl. H05B 37/02

(52) U.S. Cl. 315/294

(57) ABSTRACT

A computer-based method for controlling lighting patterns of an LED is disclosed. The method includes the steps of: adding LED data to a computer, the LED data includes a lighting pattern of the LED; sending a command to an LED controller connected to the LED, the command is a control command or a writing command, the writing command includes LED data that can be read by the computer; updating LED data stored in the LED controller with the LED data included in the writing command if the command is the writing command, and controlling the lighting pattern of the LED according to the updated LED data; reading LED data from the LED controller directly if the command is the control command, and controlling the LED to turn on or turn off according to the LED data read from the LED controller. A related system is also disclosed.

### BACKGROUND

1. Field of the Invention

The present invention is related to a system and method for controlling lighting patterns of an LED.

2. Description of Related Art

At the present time, Light Emitting Diodes (LEDs) are often used in computers as status indicators. A lighting pattern of the LED is set when the computer is manufactured. The users cannot change the fixed lighting pattern according to different computer status.

Therefore, what is needed is a system and method for controlling lighting patterns of an LED which can automatically change the lighting patterns of the LED when the computer status is changed.

### SUMMARY

A system for controlling lighting patterns of an LED is provided in accordance with a preferred embodiment. The system includes a computer and an LED controller. The LED controller connects to the computer and the LED. The computer includes a setting module and a command sending module. The LED controller includes a controlling module. The setting module is configured for adding LED data to the computer, the LED data includes a lighting pattern of the LED. The command sending module is configured for sending a command to the LED controller, the command being a control command or a writing command, the writing command includes LED data that can be read by the computer. The controlling module is configured for updating LED data stored in the LED controller with the LED data included in the writing command if the command is the writing command, and controlling the lighting pattern of the LED according to the updated LED data. The controlling module is further configured for reading LED data from the LED controller directly if the command is the control command, and controlling the LED to turn on or turn off according to the LED data read from the LED controller.

Other systems, methods, features, and advantages of the present invention will become apparent to one with skill in the art upon examination of the following drawings and detailed description.

### BRIEF DESCRIPTION OF THE DRAWINGS

FIG. 1 is a schematic diagram of hardware configuration of a system for controlling lighting patterns of an LED in accordance with a preferred embodiment;

FIG. 2 is a schematic diagram showing function modules of the system of FIG. 1; and

FIG. 3 is a flowchart of a preferred method for controlling lighting patterns of an LED in accordance with one embodiment.

### DETAILED DESCRIPTION OF THE EMBODIMENTS

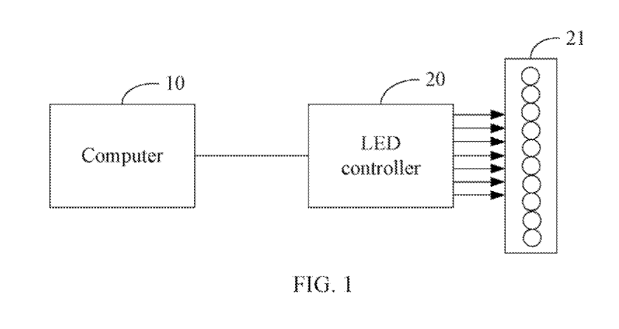

FIG. 1 is a schematic diagram of hardware configuration of a system for controlling lighting patterns of an LED (hereinafter, “the system”) in accordance with a preferred embodiment. The system typically includes a computer 10 and an LED controller 20. The LED controller 20 connects with the computer 10 and an LED 21 to be controlled. The LED controller 20 may connect to the computer 10 through an Inter-integrated Circuit (I2C) data bus or any other suitable data bus. The computer 10 provides a software interface for users to add LED data and set LED data corresponding to each computer status. The LED data may include a lighting pattern of the LED 21 and a delay time of the lighting. The computer status may be one of a normal status, an over frequency status, and a warning status. The LED controller 20 stores default LED data when it is manufactured. The software interface is further configured for the users to set modes for controlling the LED 21. The modes may be a fixed mode or a variable mode. The computer 10 sends a command to the LED controller 20 through the I2C data bus when the computer status is changed, then the LED controller 20 controls the lighting pattern of the LED 21 according to the command.

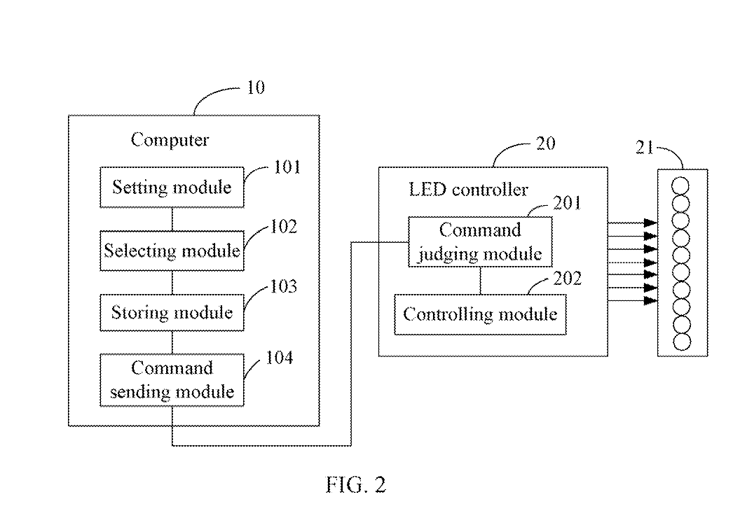

FIG. 2 is a schematic diagram showing function modules of the system of FIG. 1. The computer 10 may include a setting module 101, a selecting module 102, a storing module 103, and a command sending module 104. The LED controller 20 may include a command judging module 201 and a controlling module 202.

The setting module 101 is configured for adding LED data to the computer 10, setting LED data corresponding to each computer status, and setting modes for controlling the LED 21. The modes may be the fixed mode or the variable mode. Under the variable mode, the computer 10 automatically reads LED data corresponding to a current computer status when the computer status is changed, and sends a writing command to the LED controller 20 through the I2C data bus. The writing command includes the LED data corresponding to the current computer status. Then, the LED controller 20 controls the lighting pattern of the LED 21 according to the LED data corresponding to the current computer status.

Under the fixed mode, there is a need to select fixed LED data from the combined LED data through the selecting module 102. The computer 10 reads the fixed LED data when the computer status is changed, and sends the writing command to the LED controller 20 through the I2C data bus. The writing command includes the fixed LED data. Then, the LED controller 20 controls the lighting pattern of the LED 21 according to the fixed LED data. That is to say, under the fixed mode, no matter what the computer status is, the computer 10 always reads the fixed LED data, and sends the writing command with the fixed LED data to the LED controller 20.

The storing module 103 is configured for storing the LED data set by the setting module 101 and the LED data selected by the selecting module 102 in the computer 10.

The command sending module 104 is configured for sending a command to the LED controller 20 through the I2C data bus. The command may be a control command or the writing command. The control command may be a command for turning on the LED 21 or a command for turning off the LED 21. The control command itself does not include LED data. The writing command is a command sent by the computer 10 if the computer status is changed. The writing command may include LED data. Under the variable mode, the LED data included in the writing command are the LED data corresponding to a current computer status. Under the fixed mode, the LED data included in the writing command are the fixed LED data selected by the selecting module 102.

The command judging module 201 is configured for judging whether the command sent from the computer 10 is the control command or the writing command. If the command is the control command, the controlling module 202 reads the LED data from the LED controller 20 directly according the control command, and controls the LED 21 to turn on or turn off according to the LED data read from the LED controller 20. If the command is the writing command, the controlling module 202 writes the LED data included in the writing command to the LED controller 20 (i.e., updating LED data stored in the LED controller 20 with the LED data included in the writing command), and controls the lighting pattern of the LED 21 according to the updated LED data.

In the preferred embodiment, the LED is installed in a graphics adapter. In other embodiments, the LED can be installed in any other hardware device.

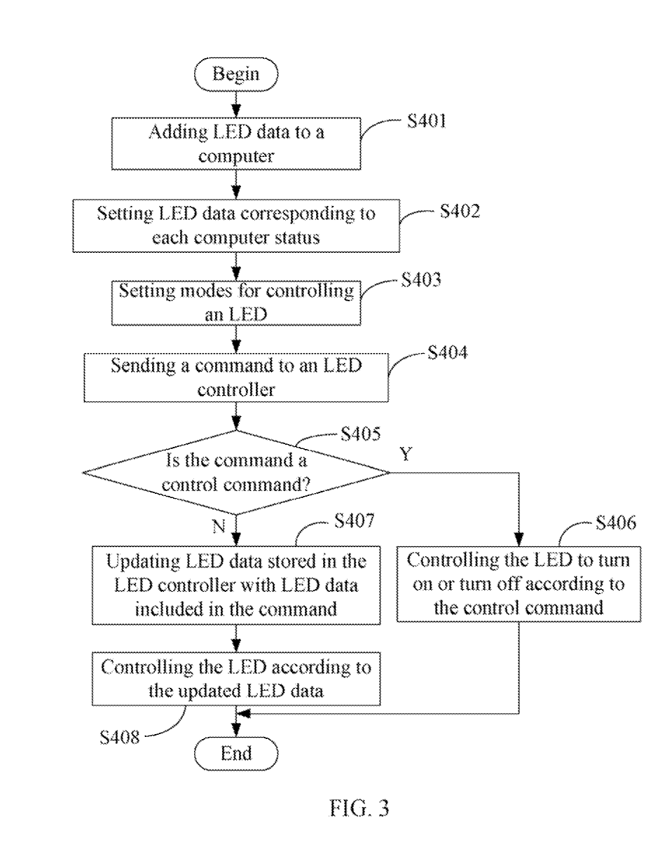

FIG. 3 is a flowchart of a preferred method for controlling lighting patterns of an LED in accordance with one embodiment. In step S401, a user adds LED data through the setting module 101 in the computer 10, and stores the added LED data in the computer 10 through the saving module 103. The LED data may include a lighting pattern of the LED and a delay time of the lighting.

In step S402, the user sets LED data corresponding to each computer status through the setting module 101, and stores the set LED data in the computer 10 through the saving module 103. The computer status may be one of the normal status, the over frequency status and the warning status.

In step S403, the user sets modes for controlling the LED 21 through the setting module 101, and stores the set modes information in the computer 10 through the saving module 103. The modes may be the fixed mode or the variable mode. Under the variable mode, the computer 10 automatically reads LED data corresponding to a current computer status when the computer status is changed, and sends the writing command to the LED controller 20 through the I2C data bus. The writing command includes the LED data corresponding to the current computer status. Then, the LED controller 20 controls the lighting pattern of the LED 21 according to the LED data corresponding to the current computer status.

Under the fixed mode, there is a need to select the fixed LED data from the combined LED data through the selecting module 102. The computer 10 reads the fixed LED data when the computer status is changed, and sends the writing command to the LED controller 20 through the I2C data bus. The writing command includes the fixed LED data. Then, the LED controller 20 controls the lighting pattern of the LED 21 according to the fixed LED data. That is to say, under the fixed mode, no matter what the computer status is, the computer 10 always reads the fixed LED data, and sends the writing command with the fixed LED data to the LED controller 20.

In step S404, the command sending module 104 sends a command to the LED controller 20 through the I2C data bus. The command may be the control command or the writing command. The control command may be the command for turning on the LED 21 or the command for turning off the LED 21. The control command itself does not include LED data. The writing command is a command sent by the computer 10 if the computer status is changed. The writing command may include LED data. Under the variable mode, the LED data included in the writing command is the LED data corresponding to a current computer status. Under the fixed mode, the LED data included in the writing command is the fixed LED data selected by the selecting module 102.

In step S405, the command judging module 201 judges whether the command sent from the computer 10 is the control command or the writing command.

If the command is the control command, in step S406, the controlling module 202 reads the LED data from the LED controller 20 directly according the control command, and controls the LED 21 to turn on or turn off according to the LED data read from the LED controller 20.

If the command is the writing command, in step S407, the controlling module 202 writes the LED data included in the writing command to the LED controller 20 (i.e., updating LED data stored in the LED controller 20 with the LED data included in the writing command).

In step S408, the controlling module 202 controls the lighting pattern of the LED 21 according to the updated LED data. In the preferred embodiment, the LED is installed in a graphics adapter. In other embodiments, the LED can be installed in any other hardware device.

It should be emphasized that the above-described embodiments of the present invention, particularly, any preferred embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for controlling lighting patterns of an LED, the system comprising a computer and an LED controller, the LED controller being connected to the computer and the LED, the computer comprising a setting module and a command sending module, the LED controller comprising a controlling module, wherein:
the setting module is configured for adding LED data to the computer, the LED data comprising a lighting pattern of the LED;
the command sending module is configured for sending a command to the LED controller, the command being a control command or a writing command, the writing command comprising LED data that can be read by the computer;
the controlling module is configured for updating LED data stored in the LED controller with the LED data included in the writing command if the command is the writing command, and controlling the lighting pattern of the LED according to the updated LED data; and
the controlling module is further configured for reading LED data from the LED controller directly if the command is the control command, and controlling the LED to turn on or turn off according to the LED data read from the LED controller.

2. The system according to claim 1, wherein the setting module is further configured for setting LED data corresponding to each computer status, the computer status being one of a normal status, an over frequency status, and a warning status.

3. The system according to claim 2, wherein the setting module is further configured for setting modes for controlling the LED, the modes comprising a fixed mode and a variable mode, wherein under the fixed mode the LED data included in the writing command are fixed LED data, and under the variable mode the LED data are LED data corresponding to a current computer status automatically read by the computer.

4. A computer-based method for controlling lighting patterns of an LED, the method comprising:
adding LED data to a computer, the LED data comprising a lighting pattern of the LED;
sending a command to an LED controller connected to the LED, the command being a control command or a writing command, the writing command comprising LED data that can be read by the computer;
updating LED data stored in the LED controller with the LED data included in the writing command if the command is the writing command, and controlling the lighting pattern of the LED according to the updated LED data; and
reading LED data from the LED controller directly if the command is the control command, and controlling the LED to turn on or turn off according to the LED data read from the LED controller.

5. The method according to claim 4, further comprising: setting LED data corresponding to each computer status, the computer status being one of a normal status, an over frequency status, and a warning status.

6. The method according to claim 5, further comprising: setting modes for controlling the LED, the modes comprising a fixed mode and a variable mode, wherein under the fixed mode, the LED data included in the writing command are fixed LED data, and under the variable mode the LED data are LED data corresponding to a current computer status automatically read by the computer.
